(19) United States
(12) Patent Application Publication
(10) Pub. No.: US 2018/0180577 A1
(43) Pub. Date: Jun. 28, 2018

(54) Combined Subsea ToFD and Phased Array Ultrasonic Inspection System

(71) Applicant: Oceaneering International, Inc., Houston, TX (US)

(72) Inventors: Stuart Kenny, Llansamlet (GB); Christopher Cull, Dyce (GB); Michael William Killeen, Houston, TX (US); Lukasz Korziuk, Dyce (GB); Colin Leggett, Dyce (GB); Leon Tripp, Dyce (GB)

(73) Assignee: Oceaneering International, Inc., Houston, TX (US)

(21) Appl. No.: 15/850,545

(22) Filed: Dec. 21, 2017

Related U.S. Application Data
(60) Provisional application No. 62/438,054, filed on Dec. 22, 2016.

(51) Int. Cl. G01N 29/26; G01N 29/24; G01N 29/07; G01N 29/22

(52) U.S. Cl. CPC G01N 29/262; G01N 29/223; G01N 29/07; G01N 29/24

(57) ABSTRACT

A scanning carriage, useful to perform simultaneous or concurrent subsea Time of Flight Diffraction (ToFD) and Phased Array Ultrasonic Testing (PAUT) of a subsea structure, comprises a housing machined to provide an incident angle for producing a predetermined set of desired refraction angles to help provide volumetric coverage of a weld in a one pass inspection; a Time of Flight Diffraction (ToFD) tool disposed proximate the housing and comprising a ToFD probe; a phased array ultrasonic testing tool, disposed proximate the ToFD tool, comprising a phased array ultrasonic probe and configured to produce multiple refracted angles with one probe placement; and a data communication link configured to interface with a data collection tool and operatively connected to the ToFD tool and the phased array ultrasonic testing tool.

### BACKGROUND

Offshore oil and gas devices, as well as other devices such as offshore wind farms with monopiles, may require inspection of subsea welds. The problem has existed since the early 1990s when subsea Time of Flight Diffraction (ToFD) was first performed. ToFD is an industry recognized non-destructive testing method for the evaluation of welds and sizing of potential flaws.

Although regarded as the most accurate ultrasonic method, as with all non-destructive testing (NDT) methods there are certain limitations. The main limitation is the data sets produced from ToFD are two dimensional (2D) and therefore unable to locate and size defects across the weld.

In recent years, ToFD has been supplemented with Phased Array (PA) technology for two main purposes: ensure coverage at the internal and external surfaces and provide cross sectional analysis of the weld. This additional information helps ensure that defects are located in ToFD dead zones and also aids in the characterization of defects by providing accurate positioning and orientation.

However, this dual method has always been limited to topside applications and there are currently no systems available that can provide ToFD and PA data simultaneously. Current subsea inspection of welds which utilize ToFD gives part of the information about a weld and often is backed up with a secondary inspection technique like Phased Array Ultrasonic Testing (PAUT) but often requires deploying an inspection tool and running one technique before recovering that inspection tool and subsequently installing and calibrating that tool or another tool to perform the second technique. This recovery, calibration and redeployment can require a many hours delay.

### BRIEF DESCRIPTION OF DRAWINGS

The figures supplied herein illustrate various embodiments of the invention. Items not expressly illustrated in the drawings are not necessary for the understanding of the subject matter sought to be patented by one of ordinary skill in these arts.

FIG. 1 is a view in partial perspective of an exemplary system;

FIG. 2 is a view in partial perspective of the exemplary system on a secondary tool and illustrating wheels;

FIG. 3 is a block view of an exemplary method; and

FIG. 4 is a further block view of an exemplary method.

### BRIEF DESCRIPTION OF INVENTION

As used herein, a subsea structure may comprise a subsea pipeline, a subsea flowline, a subsea jumper, a subsea riser, or the like, or a combination thereof.

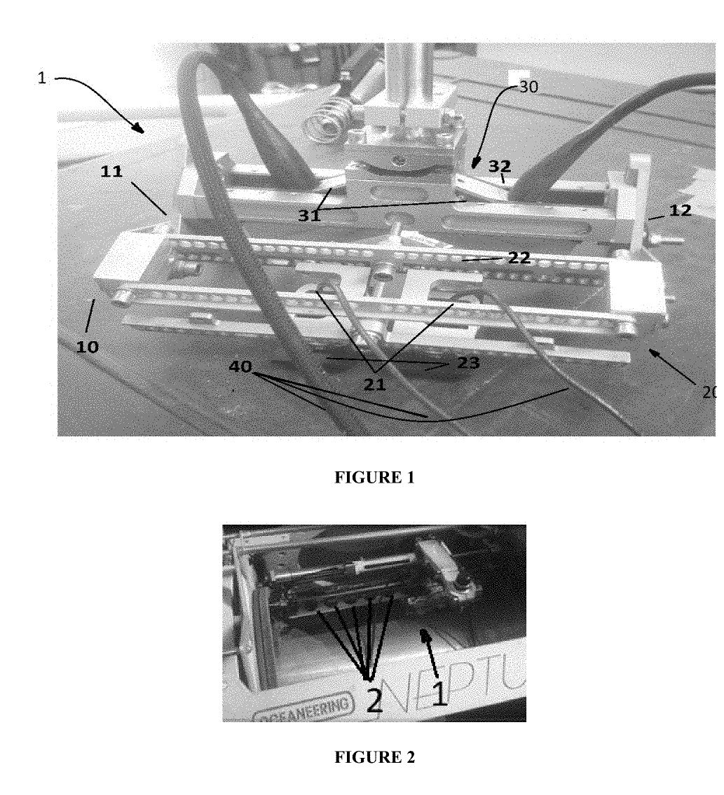

Referring now to FIG. 1, scanning carriage 1, which is useful for performing simultaneous or concurrent subsea Time of Flight Diffraction (ToFD) and Phased Array Ultrasonic Testing (PAUT) functions, comprises housing 10; Time of Flight Diffraction (ToFD) tool 20 disposed proximate the housing, ToFD tool 20 comprising one or more ToFD probes 21; phased array ultrasonic testing tool 30 disposed proximate ToFD tool 20, phased array ultrasonic testing tool 30 comprising one or more phased array ultrasonic probes 31, where phased array ultrasonic testing tool 30 is configured to produce multiple refracted angles with one probe placement; and one or more data communication links 40 operatively connected to ToFD tool 20 and phased array ultrasonic testing tool 30, where data communication link 40 is configured to interface with a data collection tool.

Scanning carriage 1 is typically ROV deployable but, in embodiments, may be diver deployable. Accordingly, in embodiments, scanning carriage 1 is configured to be deployable on a magnetic/mechanical subsea crawler, via a diver, or via a remotely operated vehicle (ROV), and/or on a scanner such as a fully automated X/Y subsea scanner or a semi-automated subsea scanner. Scanning carriages such as scanning carriage 1 will be similar for each of these deployment methods as the angle of the probes, i.e. ToFD probe 21 and/or phased array ultrasonic probe 31, will be determined by the pipe being inspected and the specification of the weld being inspected. For each of these deployment methods, scanning carriage 1 will then be interfaced mechanically to its associated scanner in order to hold/manipulate scanning carriage 1 and electrically to provide power and communications to/from a power and/or data communications source such as subsea bottle or topside control system.

In certain configurations, scanning carriage 1 comprises a set of carriage wheels 2 (FIG. 2).

Scanning carriage 1 may be configured to gimble to maintain a desired incident angle of probes 21,31 to a surface of a structure being inspected.

Further, scanning carriage 1 may be deployed under constant tension so as to maintain contact between ToFD probes 21 and a surface a structure being inspected. This constant tension may be provided, for example, by springs (not shown in the figures) on scanning carriage 1 and/or on an associated scanner.

Housing 10 typically comprises a material suitable for use subsea at a deployment of at least 3000 m and is machined to provide an incident angle for producing a predetermined set of desired refraction angles to help provide volumetric coverage of a weld in a one pass inspection. In embodiments, housing 10 further comprises a set of end plates 11,12. In these configurations, ToFD tool 20 typically comprises ToFD tool carriage 22 which is connected to a first predetermined end plate 11 of the set of end plates and phased array ultrasonic testing tool 30 comprises phased array ultrasonic testing tool carriage 32 connected to a second predetermined end plate 12 of the set of end plates at an angle such that when connected the angle holds the phased array ultrasonic testing tool probe substantially perpendicular to an outer surface of a structure to be examined using scanning carriage 1 for performing simultaneous or concurrent subsea ToFD and phased array ultrasonic testing.

ToFD probe 21 may comprise a plurality of ToFD probes 21. In embodiments, ToFD tool 20 may further comprise a predetermined set of ToFD shoes 23 configured to act as a contact stabilizer and keep a standoff dimension of phased array ultrasonic testing tool 30 in a manner similar to wheels 2 (FIG. 2).

Phased array ultrasonic probe 31 typically comprises a set of phased array ultrasonic probes 31, e.g. two or more such probes. In such configurations, the set of phased array ultrasonic probes 31 are typically set at an incident angle sufficient to offset cross talk between the set of the phased array ultrasonic probes 31.

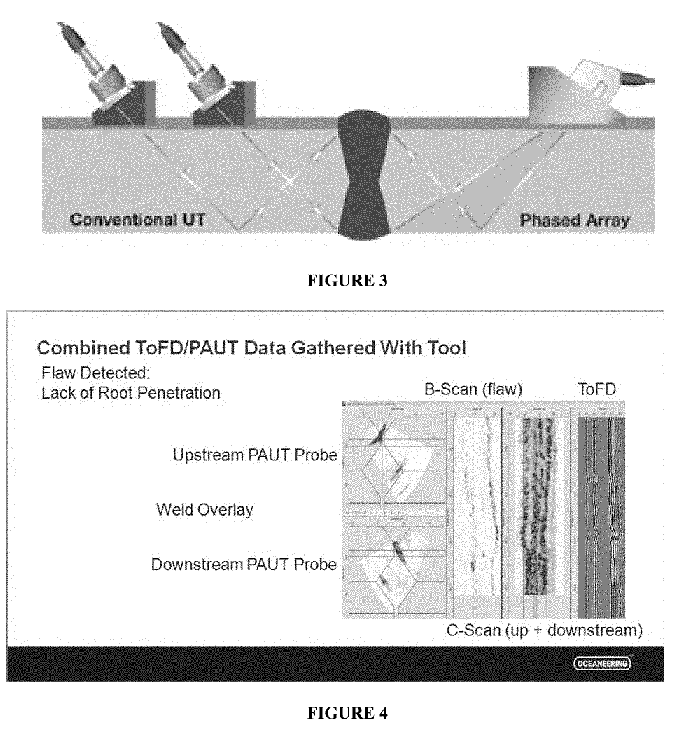

In the operation of exemplary embodiments, referring additionally to FIGS. 3 and 4, inspection of a subsea structure in a single pass may comprise deploying scanning carriage 1, which is as described above, proximate a subsea structure and, in a single pass, passing scanning carriage 1 over or proximate to that subsea structure to perform substantially concurrent subsea Time of Flight Diffraction (ToFD) and Phased Array Ultrasonic Testing (PAUT) functions about the subsea structure at a predetermined angle with respect to the subsea structure while providing a multiple pulse echo inspection. Scanning carriage 1 may then be used to perform simultaneous, i.e. substantially concurrent, subsea ToFD and PAUT functions to gather data related to the subsea structure. In certain embodiments, a substantially simultaneous or concurrent collection of ToFD and/or PAUT data occurs without mechanically adjusting set up of scanning carriage 1.

Data so gathered may be provided from scanning carriage 1 to an analyzer such as via data communication links 40 (FIG. 1). As used herein, an analyzer is typically a data processing system which can be located anywhere, including subsea, at a vessel, or remotely such as a shore location. Providing data from scanning carriage 1 to the analyzer typically occurs in real-time and, typically, data gathered from ToFD tool 20 and phased array tool 30 are gathered substantially simultaneously. Providing data typically comprises providing data sufficient to detect a crack or other defect in the subsea structure if such is present. In addition, providing data may further comprise using the analyzer to find inner diameter and/or outer diameter (ID/OD) connected defects.

Further, if one or more cracks are discovered, the analyzer may be used to determine a crack's morphology as well as providing accurate sizing by using complimentary ultrasonic inspection techniques of phased array ultrasonic testing.

If housing 10 comprises a set of end plates 11,12 and ToFD tool 20, which are as describe above, interference may be lessened between the two ultrasonic inspection techniques being deployed by probes 21,32 by having phased array ultrasonic testing tool carriage 32 and ToFD tool carriage 22 offset in a transverse plane, typically by around 63 mm to avoid crosstalk. An offset between PAUT probes 32 and ToFD probes 31 may be maintained in a transverse direction, such as by the positional placement of probes 21,32 within scanning carriage 1. In certain embodiments where phased array ultrasonic testing tool 30 comprises a plurality of phased array ultrasonic probes 31 and ToFD tool 20 comprises a plurality of ToFD probes 21, a combination of multiple ToFD probes 21 and PAUT probes 31 may be used at similar or different incident angles in one transverse pass.

Where scanning carriage 1 comprises a set of carriage wheels 2 (FIG. 2), scanning carriage 1 may be deployed under constant tension, as described above, so as to maintain contact between the set of carriage wheels 2 and a surface of a structure being inspected.

Scanning carriage 1 may be kept under constant tension so as to maintain a water gap standoff between PAUT probes 32 and a surface a structure being inspected, e.g. by use of springs as described above.

Where phased array ultrasonic testing tool 30 comprises a plurality of phased array ultrasonic probes 32, multiple PAUT probes 32 may be used in one transverse pass and/or at different incident angles in one transverse pass. In other embodiments, multiple ToFD probes 21 may be used in one transverse pass and/or at different incident angles in one transverse pass.

The foregoing disclosure and description of the inventions are illustrative and explanatory. Various changes in the size, shape, and materials, as well as in the details of the illustrative construction and/or an illustrative method may be made without departing from the spirit of the invention.

1. A scanning carriage for performing simultaneous or concurrent subsea Time of Flight Diffraction (ToFD) and Phased Array Ultrasonic Testing (PAUT), comprising:
a. a housing comprising a material suitable for use subsea, the housing machined to provide an incident angle for producing a predetermined set of desired refraction angles to help provide volumetric coverage of a weld in a one pass inspection;
b. a Time of Flight Diffraction (ToFD) tool disposed proximate the housing, the ToFD tool comprising a ToFD probe;
c. a phased array ultrasonic testing tool disposed proximate the ToFD tool, the phased array ultrasonic testing tool comprising a phased array ultrasonic probe, the phased array ultrasonic testing tool configured to produce multiple refracted angles with one probe placement; and
d. a data communication link operatively connected to the ToFD tool and the phased array ultrasonic testing tool, the data communication link configured to interface with a data collection tool.

2. The scanning carriage for performing simultaneous or concurrent subsea Time of Flight Diffraction (ToFD) and Phased Array Ultrasonic Testing (PAUT) of claim 1, wherein:
a. the housing comprises a set of end plates;
b. the ToFD tool comprises a ToFD tool carriage connected to a first predetermined end plate of the set of end plates;
c. the phased array ultrasonic testing tool comprises a phased array ultrasonic testing tool carriage connected to a second predetermined end plate of the set of end plates at an angle such that when connected to the second predetermined end plate the angle holds the phased array ultrasonic testing tool probe substantially perpendicular to an outer surface of a structure to be examined using the scanning carriage for performing simultaneous or concurrent subsea ToFD and phased array ultrasonic testing.

3. The scanning carriage for performing simultaneous or concurrent subsea Time of Flight Diffraction (ToFD) and Phased Array Ultrasonic Testing (PAUT) of claim 1, wherein the phased array ultrasonic probe comprises a plurality of phased array ultrasonic probes.

4. The scanning carriage for performing simultaneous or concurrent subsea Time of Flight Diffraction (ToFD) and Phased Array Ultrasonic Testing (PAUT) of claim 1, wherein the ToFD probe comprises a plurality of ToFD probes.

5. The scanning carriage for performing simultaneous or concurrent subsea Time of Flight Diffraction (ToFD) and Phased Array Ultrasonic Testing (PAUT) of claim 1, wherein the scanning carriage is ROV deployable or diver deployable.

6. The scanning carriage for performing simultaneous or concurrent subsea Time of Flight Diffraction (ToFD) and Phased Array Ultrasonic Testing (PAUT) of claim 1, wherein the ToFD tool comprises a predetermined set of ToFD shoes configured to act as a contact stabilizer and keep a stand-off dimension of the phased array ultrasonic testing tool the same as with wheels attached.

7. A method for the inspection of a subsea structure in a single pass, comprising:
a. deploying a scanning carriage for performing simultaneous or concurrent subsea Time of Flight Diffraction (ToFD) and Phased Array Ultrasonic Testing (PAUT) proximate a subsea structure, the scanning carriage for performing simultaneous or concurrent subsea Time of Flight Diffraction (ToFD) and Phased Array Ultrasonic Testing (PAUT), comprising a housing comprising a material suitable for use subsea and machined to provide an incident angle for producing a predetermined set of desired refraction angles to help provide volumetric coverage of a weld in a one pass inspection, a Time of Flight Diffraction (ToFD) tool disposed proximate the housing, the ToFD tool comprising a ToFD probe, a phased array ultrasonic testing tool disposed proximate the ToFD tool, the phased array ultrasonic testing tool comprising a phased array ultrasonic probe, the phased array ultrasonic testing tool configured to produce multiple refracted angles with one probe placement, and a data communication link operatively connected to the ToFD tool and the phased array ultrasonic testing tool, the data communication link configured to interface with a data collection tool;
b. in a single pass, passing the scanning carriage for performing simultaneous or concurrent subsea Time of Flight Diffraction (ToFD) and Phased Array Ultrasonic Testing (PAUT) proximate the subsea structure at a predetermined angle with respect to the subsea structure while providing a multiple pulse echo inspection;
c. using the scanning carriage for performing simultaneous or concurrent subsea Time of Flight Diffraction (ToFD) and Phased Array Ultrasonic Testing (PAUT) to gather data related to the subsea structure from the ToFD tool and the phased array ultrasonic testing tool; and
d. providing the data from the scanning carriage to an analyzer.

8. The method for the inspection of a subsea structure in a single pass of claim 7, wherein providing data from the scanning carriage to the analyzer occurs in real-time.

9. The method for the inspection of a subsea structure in a single pass of claim 7, wherein the subsea structure comprises a subsea pipeline, a subsea flowline, a subsea jumper, and/or a subsea riser.

10. The method for the inspection of a subsea structure in a single pass of claim 7, wherein providing data from the scanning carriage to an analyzer further comprises providing data sufficient to detect a crack in the subsea structure if such is present.

11. The method for the inspection of a subsea structure in a single pass of claim 7, wherein providing data from the scanning carriage to the analyzer further comprises using the analyzer to find inner diameter and/or outer diameter (ID/OD) connected defects.

12. The method for the inspection of a subsea structure in a single pass of claim 7, wherein the data gathered from the ToFD tool and the phased array ultrasonic testing tool are gathered substantially simultaneously.

13. The method for the inspection of a subsea structure in a single pass of claim 7, wherein the housing comprises a set of end plates, the ToFD tool comprises a ToFD tool carriage connected to an end plate of the set of end plates, the phased array ultrasonic testing tool comprises a phased array ultrasonic testing tool carriage connected to an end plate of the set of end plates at an angle such that when connected the angle holds the phased array ultrasonic testing tool probe substantially perpendicular to an outer surface of a structure to be examined using the scanning carriage for performing simultaneous or concurrent subsea Time of Flight Diffraction (ToFD) and Phased Array Ultrasonic Testing (PAUT), the method further comprising lessening interference between the ToFD tool and the phased array ultrasonic testing tool by having the phased array ultrasonic testing tool carriage and the ToFD tool carriage offset in a transverse plane.

14. The method for the inspection of a subsea structure in a single pass of claim 7, wherein the phased array ultrasonic testing tool comprises a set of phased array ultrasonic probes set at an incident angle sufficient to offset cross talk between set of the phased array ultrasonic probes.

15. The method for the inspection of a subsea structure in a single pass of claim 7, wherein the phased array ultrasonic testing tool comprises a plurality of phased array ultrasonic probes, the method further comprising using multiple phased array ultrasonic probes in one transverse pass.

16. The method for the inspection of a subsea structure in a single pass of claim 7, wherein the phased array ultrasonic testing tool comprises a plurality of phased array ultrasonic probes, the method further comprising using multiple phased array ultrasonic probes at different incident angles in one transverse pass.

17. The method for the inspection of a subsea structure in a single pass of claim 7, wherein the ToFD tool comprises a plurality of ToFD probes, the method further comprising using multiple ToFD probes in one transverse pass.

18. The method for the inspection of a subsea structure in a single pass of claim 7, wherein the phased array ultrasonic testing tool comprises a plurality of phased array ultrasonic probes and the ToFD tool comprises a plurality of ToFD probes, the method further comprising using using a combination of multiple ToFD probes and PAUT probes at similar or different incident angles in one transverse pass.
